(19) United States
(12) Patent Application Publication
(10) Pub. No.: US 2026/0145114 A1
(43) Pub. Date: May 28, 2026

(54) METHOD FOR SEPARATING CARBON DIOXIDE FROM THE AMBIENT AIR AND FACILITY FOR CARRYING OUT SUCH A METHOD

(71) Applicants: VOLKSWAGEN AG, Wolfsburg (DE); EVERLLENCE SE, Augsburg (DE)

(72) Inventors: Peter Kawelke, Wolfsburg (DE); Klaus Behnke, Schriesheim (DE)

(21) Appl. No.: 18/992,461

(22) PCT Filed: Jul. 6, 2023
(86) PCT No.: PCT/EP2023/068638

§ 371 Date: Jan. 8, 2025

(30) Foreign Application Priority Data
Jul. 13, 2022 (DE) 10 2022 117 409.3

(51) Int. Cl. B01D 53/04

(52) U.S. Cl. CPC B01D 53/0438; B01D 2257/504; B01D 2258/06; B01D 2259/40086; B01D 2259/4009

(57) ABSTRACT

A method for separating carbon dioxide from ambient air includes feeding ambient air into a process chamber of a facility configured to separate carbon dioxide and conducting the air through an adsorption unit. Carbon dioxide is temporarily stored in the adsorption unit and later released by at least partially evacuating the process chamber and heating the adsorption unit. An inert gas, such as steam, may be introduced into the process chamber to assist in releasing the temporarily stored carbon dioxide from the adsorption unit and to increase the carbon dioxide concentration within the process chamber. The facility is configured to perform this method.

### RELATED APPLICATIONS

The present application claims priority to International Patent Application No. PCT/EP 2023/068638 to Peter Kawelke et al., filed Jul. 6, 2023, titled “Method For Separating Carbon Dioxide From The Ambient Air And Facility For Carrying Out Such A Method,” which claims priority to German Patent Application No. 10 2022 117 409.3, filed Jul. 13, 2022, the contents of each being incorporated by reference in their entirety herein.

### TECHNICAL FIELD

The present disclosure relates technologies and techniques for separating carbon dioxide (CO₂) from the ambient air and to a facility for carrying out such a method.

### BACKGROUND

So as to reduce the carbon dioxide content in the ambient air and achieve climate neutrality, it is not only necessary to decrease the emission of carbon dioxide but also to appropriately compensate for unavoidable carbon dioxide emissions. One option for compensating for these emissions is to capture carbon dioxide from the ambient air. This method is also referred to as direct air capture. Alternatively, carbon dioxide emissions can be compensated for by permanently sequestering carbon dioxide in a storage reservoir, particularly in a rock formation, thereby preventing it from entering the atmosphere.

In principle, facilities and methods for capturing carbon dioxide from the ambient air are known. Such a capturing process can be carried out, for example, using the so-called “direct air capture” method, where carbon dioxide is captured directly from the ambient air and supplied to a further process.

The majority of known methods for separating carbon dioxide from the ambient air operate based on a combination of pressure and temperature swing processes. Depending on the selection of the negative pressure during desorption, the temperature ranges between adsorption and desorption, and the properties of the sorbent material, it is possible to achieve a purity of carbon dioxide in the product stream of more than 70%. Very high purity, in excess of 95%, is usually only possible when using a strong vacuum during desorption.

In addition, multi-stage processes are known from the prior art, during which the described adsorption units operate in a cascade manner, one behind the other. In this process, the product stream of a first unit is conducted as the adsorption medium to a second unit. Depending on the selection of the negative pressure (vacuum) during desorption, the temperature ranges between adsorption and desorption, and the properties of the sorbent material, at least two, and in general five to ten stages, are necessary to achieve very high purity of greater than 95% or even greater than 99%. With a multi-stage process, the design complexity of the overall facility is correspondingly high.

A method for capturing carbon dioxide from the ambient air is known from WO 2016/005 226 A1. The carbon dioxide is captured from the ambient air in a temperature vacuum swing process and adsorbed on a sorbent. However, the disadvantage of such a method is that a strong negative pressure of up to 50 mbar absolute pressure is generated during a desorption phase. This means that very high requirements are placed on the facility design so as to achieve the necessary strength and leak tightness. These high requirements are associated with accordingly high system costs, making the process expensive and complex.

A method and a system for separating carbon dioxide (CO₂) from a CO₂-containing gas stream containing water vapor and additional impurities, for example, nitrogen, oxygen, sulfur oxides, and mercury, is known from US 2010/0 251 887 A1. The CO₂ is captured by subjecting the CO₂ gas stream to a temperature swing adsorption step. The temperature swing adsorption step comprises an adsorption step for producing a substantially dry, carbon dioxide-depleted stream, and an adsorbent regeneration step comprising heating the adsorbent bed to produce a substantially water vapor-free carbon dioxide stream. Moisture from the gas stream containing CO₂ is optionally removed by pressure swing adsorption, temperature swing adsorption, membrane separation, or absorption prior to CO₂ capture.

A pressure swing adsorption method for removing CO2 from natural gas streams is known from US 2014/0 033 919 A1. The method enables the removal of contaminants from gas streams, preferably natural gas streams, using rapid cycle swing adsorption methods, such as rapid cycle pressure swing adsorption (RC-PSA). Separations at high pressure with high product recovery and/or high product purity are provided through a combination of judicious choices of adsorbent material, gas-solid contactor, system configuration, and cycle designs.

### SUMMARY

Aspects of the present disclosure are directed to capturing carbon dioxide in a comparatively simple and cost-effective manner from the ambient air and to overcome the disadvantages known from the prior art.

In some examples, a method is disclosed for separating carbon dioxide from the ambient air, comprising: supplying ambient air to a facility for separating carbon dioxide from the ambient air; conducting ambient air into a process area comprising an adsorption unit, wherein the ambient air is conducted through the adsorption unit, and carbon dioxide is essentially chemically bound in the adsorption unit; sealing the process area so as to prevent an inflow of ambient air into the process area; evacuating the process area; heating the adsorption unit; releasing carbon dioxide from the adsorption unit, wherein a carbon dioxide concentration in the process area increases; introducing an inert gas into the process area, wherein the introduction of the inert gas causes additional carbon dioxide to be discharged from the adsorption unit and the carbon dioxide concentration in the process area to increase; and opening the process area and removing a carbon dioxide/inert gas mixture by suction.

As used herein, an inert gas may be understood to mean a gas that does not undergo a reaction with carbon dioxide under the conditions prevailing in the process area. Furthermore, the inert gas also does not react with the sorbent material in the adsorption unit. Examples of suitable inert gases include nitrogen (N₂) and the noble gases as well as water vapor.

In some examples, the method enables an improved yield of carbon dioxide, which is obtained from the carbon dioxide that is chemically bound in the adsorption unit, with less strain on the facility and lower requirements with regard to the facility components. While a portion of the carbon dioxide bound in the adsorption unit must be blown off into the surroundings in the methods known from the prior art for separating carbon dioxide so as to achieve high purity of the carbon dioxide, the yield of carbon dioxide separated from the ambient air can be increased by way of the proposed method. Moreover, the requirements with regard to the evacuation of the process area are considerably lower than with methods known from the prior art, so that the requirements with regard to the materials, and in particular with regard to a vacuum pump and the seals of the process area, are considerably lower. Furthermore, the requirements with regard to the design configuration of the process area itself are lower since less structural rigidity in the process area is sufficient compared to known solutions, and the process area can therefore have a simpler and more cost-effective design, without irreversibly deforming under the negative pressure. As a result, these requirements can be implemented with comparatively cost-effective materials and facility components, making the proposed method accordingly cost-effective.

Aspects of the present disclosure are described in the independent claims, and further aspects are described in the dependent claims, where advantageous refinements and enhancements of the method described in the independent claim for separating carbon dioxide from the ambient air are possible.

In some examples, a facility for separating carbon dioxide from the ambient air is disclosed, which is configured to carry out any of the methods described herein for separating carbon dioxide from the ambient air and subsequently remoistening the waste air. Such a facility makes a simple, efficient, and inexpensive method for separating carbon dioxide from the ambient air possible. In particular, carbon dioxide can be separated particularly effectively from the ambient air by way of such a facility, and the amount of separated carbon dioxide can be maximized.

The various specific embodiments described in the present disclosure can advantageously be combined with one another, unless they are implemented differently in the individual case.

### BRIEF DESCRIPTION OF THE DRAWINGS

Aspects of the present disclosure will be described hereafter in exemplary embodiments based on the associated drawings. In the drawings:

FIG. 1 shows an exemplary embodiment of a facility for separating carbon dioxide from the ambient air, according to some aspects of the present disclosure;

FIG. 2 shows a flow chart for carrying out a method for separating carbon dioxide from the ambient air, according to some aspects of the present disclosure; and

FIG. 3 shows a diagram for loading/unloading a sorbent material into/from a process area of such a facility, according to some aspects of the present disclosure.

### DETAILED DESCRIPTION

According to some examples of the present disclosure, the inert gas may be water vapor, wherein the water contained in the water vapor is separated from the carbon dioxide/inert gas mixture by condensation after the carbon dioxide/inert gas mixture has been removed by suction. Water vapor is a comparatively inexpensive and readily available inert gas for the described method. For example, water vapor can be easily separated from a gas stream containing carbon dioxide and residual air, allowing for the removal of water vapor from the carbon dioxide so that carbon dioxide with a purity of more than 95%, and preferably more than 99%, can be produced.

In certain configurations, the condensed water may be evaporated again and supplied to the process area as water vapor. The water may thus circulate and be recovered in a simple manner, eliminating the need to supply inert gas from an external source. By condensing the water vapor from the gas stream and supplying it to a steam generator, a closed circuit for the inert gas may be formed, preventing the release of water into the environment.

In some examples of the disclosed method, a carbon dioxide/residual air gas mixture, comprising the released carbon dioxide and the residual air present in the process area, may be collected and supplied to an intermediate storage unit after the adsorption unit has been heated. Supplying the carbon dioxide/residual air gas mixture from the process area to an intermediate storage unit can enhance the yield of carbon dioxide, capturing additional carbon dioxide from the ambient air.

In certain configurations, the carbon dioxide/residual air gas mixture may be compressed to a pressure greater than the ambient pressure of the facility. To enable straightforward supply to the intermediate storage unit, it is advantageous if the carbon dioxide/residual air gas mixture removed by suction from the at least partially evacuated process area is compressed and then supplied to the intermediate storage unit. A simple gas tank may be utilized as the intermediate storage unit, avoiding the need for additional evacuation of the unit.

In some examples, the carbon dioxide/residual air gas mixture from the intermediate storage unit may be supplied back to the process area. This can significantly increase the carbon dioxide concentration in the gas stream supplied to the process area, thereby enhancing the yield during carbon dioxide separation from the ambient air. While ambient air contains approximately 420 ppm carbon dioxide, the carbon dioxide/residual air gas mixture from the intermediate storage unit may have a carbon dioxide concentration of approximately 30 to 35%. This increase can improve the chemical sorption of carbon dioxide in the adsorption unit.

In certain configurations, the circulation of the carbon dioxide/residual air gas mixture via the intermediate storage unit back into the process area may be repeated until a defined threshold value for the carbon dioxide concentration is reached. This approach can result in a carbon dioxide gas stream with a concentration of at least 95%, preferably at least 98%, and particularly preferably at least 99%. Such a pure carbon dioxide gas stream may be suitable for use as process gas in another facility, such as a facility for producing combustible fuel.

In additional examples of the method, the pressure in the process area may be lowered to an absolute pressure of 300 mbar to 700 mbar, preferably 400 mbar to 600 mbar, during evacuation of the process area. Lowering the pressure in the process area can facilitate recovery of carbon dioxide chemically bound in the adsorption unit. Compared to prior methods, a relatively low negative pressure may be used for the operation of the disclosed method, reducing technological demands on the facility. This can include reduced requirements for the vacuum pump, sealing components, and other facility components in the process area exposed to such a vacuum.

In certain configurations, the adsorption unit and/or sorbent material (sorption medium) within the adsorption unit may be heated to a temperature of 80° C. to 110° C., preferably 85° C. to 100° C., and particularly preferably 90° C. to 95° C., to release bound carbon dioxide. Heating the sorbent material facilitates detachment of the chemically bound carbon dioxide from the sorbent material of the adsorption unit. The specified temperature range allows for efficient detachment of the bound carbon dioxide while preventing thermal damage to the sorbent material, ensuring safe operation.

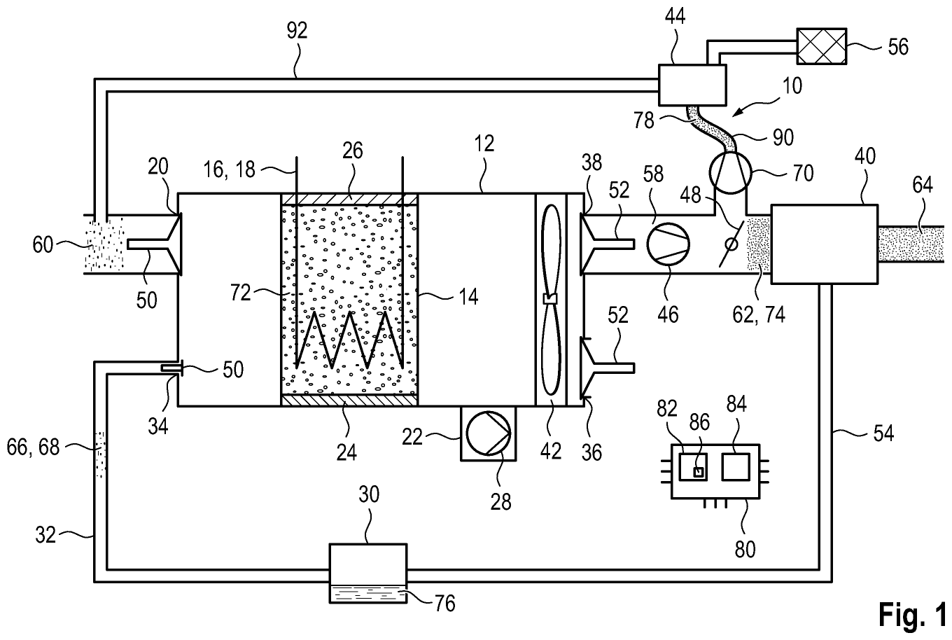

FIG. 1 shows a facility 10 according to the present disclosure for separating carbon dioxide from ambient air 60 in a schematic illustration. The facility 10 comprises a process area 12 in which an adsorption unit 14 for chemically adsorbing carbon dioxide is arranged. The adsorption unit 14 comprises a sorbent material 72, which chemically binds and removes carbon dioxide from the ambient air 60. In particular, amine-functionalized, porous materials are suitable sorbent materials 72. The sorbent material 72 is also referred to as a chemisorbent. The sorbent material 72 is maintained in the form of a packed bed in the adsorption unit 14. The adsorption unit 14, arranged in the process area 12, can be heated by a temperature control unit 16, specifically by a heat exchanger 18. The process area 12 has a first inlet 20 through which ambient air 60 can flow into the process area 12. The facility 10 furthermore comprises a flow generator 42, specifically a fan, for conducting an air current of ambient air 60 through the process area 12. The process area 12 has a first inlet 20 for introducing ambient air 60 into the process area 12, which can be closed by an inlet valve 50. The process area 12 also has a second inlet 34, via which the process area 12 can be flooded with an inert gas 66, specifically water vapor 68. The second inlet 34 can be closed by a further inlet valve 50.

The process area 12 can be heated and/or cooled by a temperature control unit 16, which is preferably designed as a heat exchanger 18. This unit is operatively connected to the process area 12 and, in particular, to the adsorption unit 14 located in the process area 12. As an alternative or in addition, the process area 12 can also be heated and/or cooled using other heating means 24 or cooling means 26. Furthermore, a pressure reduction unit 22 is provided in the process area 12 to at least partly evacuate the area and lower the absolute pressure to below ambient pressure. The pressure reduction unit 22 comprises, in particular, a vacuum pump 28, which is configured to lower the pressure in the process area 12 to an absolute pressure of 300 mbar to 700 mbar, and preferably to 400 mbar to 600 mbar.

The process area 12 also includes a first outlet 36, which is preferably connected to the surroundings, and a second outlet 38, through which a carbon dioxide-rich gas stream 62, 64, 74, 78 can be discharged from the process area 12. Both the first outlet 36 and the second outlet 38 can be closed by corresponding outlet valves 52, sealing the process area 12 from the surroundings in a gas-tight manner.

The facility 10 further comprises a steam generator 30, which is connected via a steam line 32 to the second inlet 34 of the process area 12. The second outlet 38 of the process area 12 is connected to a condenser 40, which removes moisture contained in the carbon dioxide-rich gas stream 62, 64, 74, 78, as well as the water vapor, from the gas stream 62, 64, 74, 78. The condenser 40 is connected via a condensate return line 54 to a storage receptacle of the steam generator 30, where the condensed water 76 can be recirculated and evaporated again to water vapor by the steam generator 30.

A second connecting line 90, which connects the connecting line 58 to an intermediate storage unit 44, branches off from the connecting line 58, which connects the process area 12 to the condenser 40. A suction unit 46 is arranged in the connecting line 58 to remove a carbon dioxide-rich gas stream 62, 64, 74, 78 by suction from the process area 12. A compressor 70 is located in the second connecting line 90 to supply a carbon dioxide/residual air gas mixture 78 to the intermediate storage unit 44. The intermediate storage unit 44 is connected via a third connecting line 92 to an inlet of the process area 12 to supply the carbon dioxide/residual air gas mixture back to the process area 12. A switching element 48 is positioned at the junction of the first connecting line 58 and the second connecting line 90, allowing a gas stream from the process area to be selectively directed through the first connecting line 58 to the condenser 40 or through the second connecting line 90 to the intermediate storage unit 44.

A moist, carbon dioxide-rich process gas 62, particularly a carbon dioxide/inert gas mixture 74, is conducted out of the process area via the first connecting line 58 and is supplied to the condenser 40. After the air moisture or water vapor 68 has been removed from the moist, carbon dioxide-rich process gas 62, a dry, carbon dioxide-rich gas results, which can be stored and supplied for further use to another process, particularly a process for producing synthetic fuel.

The facility 10 furthermore comprises a control unit 80 that includes a memory unit 82 and a processing unit 84, in which machine-readable program code 86 is stored. When this program code 86 is executed by the processing unit 84, the control unit 80 manages the method described hereafter for separating carbon dioxide from the ambient air 60.

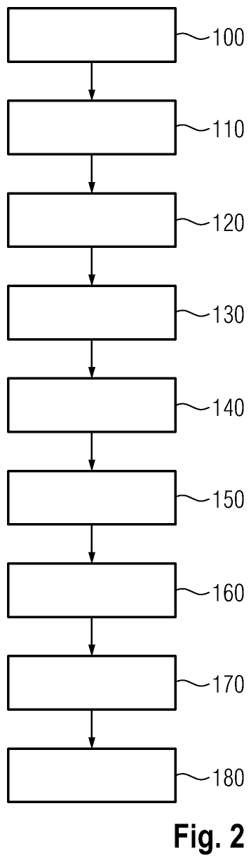

FIG. 2 shows a method according to the present disclosure for separating carbon dioxide from the ambient air 60. The method is configured as a temperature pressure swing method and runs through two cyclic main process steps: an adsorption phase, in which carbon dioxide from the ambient air 60 is chemically bound, and a desorption phase, in which this carbon dioxide is released. In a first method step <100>, the ambient air 60 is conducted through the adsorption unit 14 in the process area 12 and is chemically bound in the sorbent material 72 in the adsorption unit 14. The ambient air 60 contains approximately 0.04 volume percent carbon dioxide. The process is maintained until the sorbent material 72 is approximately 80% saturated. Further loading of the sorbent material up to 100% saturation is possible, but results in a disproportionately high time expenditure in relation to the amount of carbon dioxide that is adsorbed. The water necessary for chemically storing the carbon dioxide is taken from the ambient air 60. Furthermore, a carbon dioxide/residual air gas mixture 78 from the intermediate storage unit 44 can be conducted into the process area 12 in method step <110>, resulting in a carbon dioxide concentration of approximately 0.5 to 2 volume percent, which is higher than the carbon dioxide concentration of the ambient air 60. These method steps are also referred to as the adsorption phase of the facility 10.

This adsorption phase is followed by a desorption phase, in which the carbon dioxide chemically bound in the sorbent material 72 is released. For this purpose, the inlet openings 20, 34, and the first outlet opening 36 are closed in method step <120>, and no further ambient air 60 is conducted through the process area 12 of the facility 10. Furthermore, the pressure in the process area 12 is lowered to an absolute pressure of 400 mbar to 600 mbar in method step <130>. In method step <140>, the sorbent material 72 is heated to a temperature of 90° C. to 95° C., causing the carbon dioxide chemically bound in the sorbent material 72 to be released. As a result of the release of carbon dioxide, the carbon dioxide concentration in the process area and the pressure in the process area increase in method step <150>. In method step <160>, the released carbon dioxide, together with the residual air present in the process area 12, is removed by suction as a carbon dioxide/residual air gas mixture 78 and conducted into the intermediate storage unit 44, maintaining the pressure in the process area 12 within the range of 400 mbar to 600 mbar. The desorption continues until a carbon dioxide atmosphere has developed in the process area. To detach further carbon dioxide from the sorbent material, water vapor 68 is introduced as the inert gas 66 into the process area 12 in method step <170> to reduce the carbon dioxide concentration. Consequently, the CO₂ concentration in the process area 12 is initially decreased. However, this allows further carbon dioxide to be released, resulting in a carbon dioxide/inert gas mixture 74 being discharged from the process area 12 as a moist, carbon dioxide-rich process gas 62. In method step <180>, the moisture is withdrawn from this moist, carbon dioxide-rich process gas 62, resulting in a dry, carbon dioxide-rich gas 64 with a carbon dioxide content of at least 95%. If no further carbon dioxide can desorb from the sorbent material 72, the process switches back to the adsorption phase, and the method steps are repeated.

During the onset of the desorption of carbon dioxide—when the process area 12 has already been evacuated to an absolute pressure of 400 mbar to 600 mbar and the sorbent material has been heated to a temperature of 90° C. to 95° C.—the residual air is also removed by suction from the process area 12, resulting in a carbon dioxide/residual air gas mixture 78. The carbon dioxide content of this gas mixture 78 increases as the desorption of carbon dioxide from the sorbent material 72 progresses. Since this gas mixture does not have the desired carbon dioxide content at the beginning of the desorption phase, it is supplied to an intermediate storage unit 44 and, during the next adsorption phase, is returned to the process area 12. For further use of the carbon dioxide (for example, sequestration), a purity of carbon dioxide greater than 95%—and ideally less than 99%—is needed. The non-pure fraction is separated from the product stream, compressed to approximately ambient pressure, and stored in the intermediate storage unit 44. This non-pure fraction has a carbon dioxide concentration of approximately 35%. The amount of carbon dioxide contained therein corresponds to about 16% of the working pass per adsorption and desorption cycle. The carbon dioxide/residual air gas mixture 78 stored in the intermediate storage unit 44 is released into the taken-in air at the end of the subsequent adsorption process. This increases the carbon dioxide concentration in the taken-in air above the level of the ambient air 60 for a certain duration, allowing more carbon dioxide to be absorbed during the adsorption phase. The non-pure fraction of the taken-in air is preferably added in a metered fashion so that, at the end of the adsorption phase, a carbon dioxide concentration between 0.4% and 1.0% is achieved in the process area 12. This increases the loading of the sorbent material 72 by 22%. During the subsequent desorption cycle, a slightly larger non-pure fraction again occurs at the beginning. Through cyclical recirculation of the non-pure fraction, an increase in the working pass and, thus, in productivity of approximately 10% is achieved.

As an alternative, the carbon dioxide/residual air gas mixture 78 from the intermediate storage unit 44 can also be supplied to a further adsorption unit 56. The adsorption units 14 and 56 can operate in a staggered manner, which allows for a reduction in both the storage time and the storage volume in the intermediate storage unit 44.

Moreover, it is possible to shorten the duration of the adsorption phase, allowing for the loading of the sorbent material 72 to end at a saturation level of 25% to 70%. Although this does not fully utilize the working capacity of the sorbent material 72, the process cycles can be advantageously shortened and may potentially offset the effects of the lower loading.

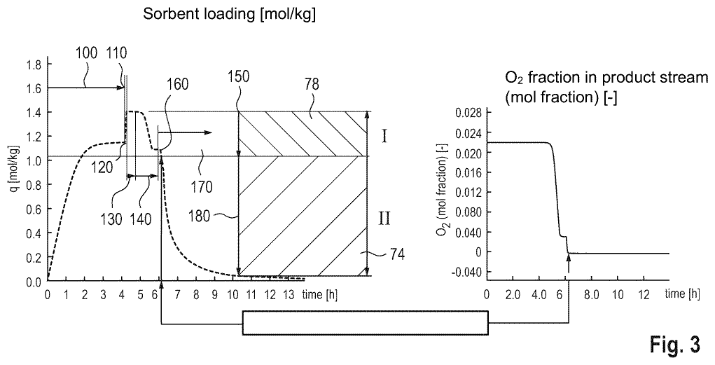

FIG. 3 shows a diagram for loading and unloading the sorbent material 72 with carbon dioxide. The method comprises the steps described with respect to FIG. 2 in the illustrated order. A working cycle thus includes a first phase I of desorption, during which a “non-pure” carbon dioxide/residual air gas mixture 78 is released, and a phase II, during which a carbon dioxide/inert gas mixture 74 is released. At the point in time XXX when the oxygen concentration in the residual gas is close to zero, the switching device is actuated, and the gas stream is no longer directed into the intermediate storage unit 44 in order to withdraw carbon dioxide with a high purity level of at least 95%, and preferably at least 99%.

### LIST OF REFERENCE NUMERALS

10 facility
12 process area
14 adsorption unit
16 temperature control unit
18 heat exchanger
20 first inlet
22 pressure reducing unit
24 heating means
26 cooling means
26 vacuum pump
30 steam generator
32 steam line
34 second inlet
36 first outlet
38 second outlet
40 condenser
42 flow generator
44 intermediate storage unit
46 suction unit
48 switching device
50 inlet valve
52 outlet valve
54 condensate return line
56 second adsorption unit
58 connecting line
60 ambient air
62 moist, carbon dioxide-rich process gas
64 dry, carbon dioxide-rich gas
66 inert gas
68 water vapor
70 compressor
72 sorbent material
74 carbon dioxide/inert gas mixture
76 water
78 carbon dioxide/residual air gas mixture
80 control unit
82 memory unit
84 processing unit
86 program code
90 second connecting line
92 third connecting line

1-10. (canceled)

11. A method for separating carbon dioxide from ambient air, comprising:
supplying ambient air to a facility configured to separate carbon dioxide from the ambient air;
conducting the ambient air into a process area comprising an adsorption unit, wherein the ambient air is conducted through the adsorption unit, and carbon dioxide is chemically bound within the adsorption unit;
sealing the process area to prevent an inflow of ambient air into the process area;
evacuating the process area;
heating the adsorption unit;
releasing carbon dioxide from the adsorption unit, wherein a concentration of carbon dioxide in the process area increases;
introducing an inert gas into the process area, wherein the introduction of the inert gas causes additional carbon dioxide to be discharged from the adsorption unit and further increases the concentration of carbon dioxide in the process area; and
opening the process area and removing a carbon dioxide/inert gas mixture from the process area by suction.

12. The method of claim 11, wherein the inert gas is water vapor, and the water contained in the water vapor is separated by condensation after the carbon dioxide/inert gas mixture is removed by suction.

13. The method of claim 12, further comprising evaporating the condensed water and supplying it to the process area as water vapor.

14. The method of claim 11, further comprising removing a carbon dioxide/residual air gas mixture from the process area by suction after the adsorption unit has been heated, wherein the carbon dioxide/residual air gas mixture comprises released carbon dioxide and residual air present in the process area.

15. The method of claim 14, further comprising compressing the carbon dioxide/residual air gas mixture to a pressure higher than an ambient pressure of the facility.

16. The method of claim 14, further comprising supplying the carbon dioxide/residual air gas mixture from an intermediate storage unit back into the process area.

17. The method of claim 16, further comprising repeating the circulation of the carbon dioxide/residual air gas mixture via the intermediate storage unit into the process area until a defined threshold value for the carbon dioxide concentration is reached.

18. The method of claim 11, wherein the pressure in the process area is lowered to an absolute pressure of between 300 mbar and 700 mbar during the evacuation of the process area.

19. The method of claim 11, wherein the adsorption unit or a sorbent material within the adsorption unit is heated to a temperature of between 80° C. and 110° C. to release the chemically bound carbon dioxide.

20. A facility for separating carbon dioxide from ambient air, comprising:
a process area configured to receive ambient air;
an adsorption unit disposed within the process area, wherein the adsorption unit comprises a sorbent material configured to chemically bind carbon dioxide from the ambient air;
a sealing mechanism configured to prevent the inflow of ambient air into the process area;
a vacuum system operatively connected to the process area, the vacuum system configured to evacuate the process area to reduce its pressure;
a heating system operatively connected to the adsorption unit, the heating system configured to heat the adsorption unit to release carbon dioxide;
an inert gas introduction system configured to introduce an inert gas into the process area, wherein the inert gas causes additional carbon dioxide to be discharged from the adsorption unit and increases the carbon dioxide concentration in the process area; and
an outlet configured to remove a carbon dioxide/inert gas mixture from the process area by suction.

21. The facility of claim 20, wherein the inert gas introduction system is configured to introduce water vapor into the process area, and the facility further comprises a condensation system configured to separate water from the carbon dioxide/inert gas mixture after the mixture is removed from the process area.

22. The facility of claim 21, further comprising a steam generator operatively connected to the condensation system, wherein the steam generator is configured to evaporate the separated water and supply it to the process area as water vapor.

23. The facility of claim 20, further comprising an intermediate storage unit operatively connected to the process area, wherein the intermediate storage unit is configured to receive a carbon dioxide/residual air gas mixture removed from the process area after the adsorption unit has been heated, wherein the carbon dioxide/residual air gas mixture comprises released carbon dioxide and residual air present in the process area.

24. The facility of claim 23, further comprising a compression system configured to compress the carbon dioxide/residual air gas mixture to a pressure higher than the ambient pressure of the facility before the mixture is supplied to the intermediate storage unit.

25. The facility of claim 23, further comprising a recirculation system operatively connecting the intermediate storage unit to the process area, wherein the recirculation system is configured to supply the carbon dioxide/residual air gas mixture from the intermediate storage unit back into the process area.

26. The facility of claim 25, wherein the recirculation system is configured to repeat the circulation of the carbon dioxide/residual air gas mixture into the process area until a defined threshold value for the carbon dioxide concentration in the process area is reached.

27. The facility of claim 20, wherein the vacuum system is configured to lower the pressure in the process area to an absolute pressure between 300 mbar and 700 mbar during evacuation.

28. The facility of claim 20, wherein the heating system is configured to heat the adsorption unit or the sorbent material within the adsorption unit to a temperature between 80° C. and 110° C. to release the chemically bound carbon dioxide.

29. A facility for separating carbon dioxide from ambient air, comprising:
a process area configured to receive ambient air and facilitate the separation of carbon dioxide;
an adsorption unit disposed within the process area, the adsorption unit comprising a material configured to capture carbon dioxide from the ambient air through chemical interaction;
a sealing mechanism operatively associated with the process area, configured to selectively prevent ambient air from entering the process area;
a pressure control system operatively connected to the process area, the pressure control system configured to adjust the pressure within the process area;
a thermal management system operatively connected to the adsorption unit, the thermal management system configured to regulate the temperature of the adsorption unit to release carbon dioxide;
a gas introduction system configured to supply a gas into the process area, wherein the gas facilitates the release of additional carbon dioxide from the adsorption unit; and
a gas removal system configured to extract a gas mixture containing carbon dioxide from the process area.

30. The facility of claim 29, wherein the gas introduction system is configured to supply water vapor into the process area, and the facility further comprises a separation system configured to extract water from a gas mixture containing carbon dioxide after the gas mixture is removed from the process area.
